(19) United States
(12) Patent Application Publication
(10) Pub. No.: US 2021/0058658 A1
(43) Pub. Date: Feb. 25, 2021

(54) ELECTRONIC APPARATUS, CONTROL METHOD THEREOF, REMOTE CONTROL APPARATUS, AND CONTROL METHOD THEREOF

(71) Applicant: SAMSUNG ELECTRONICS CO., LTD., Suwon-si, Gyeonggi-do (KR)

(72) Inventor: Byoungchul KIM, Suwon-si (KR)

(73) Assignee: SAMSUNG ELECTRONICS CO., LTD., Suwon-si, Gyeonggi-do (KR)

(21) Appl. No.: 16/965,485

(22) PCT Filed: Jan. 14, 2019
(86) PCT No.: PCT/KR2019/000552

§ 371 Date: Jul. 28, 2020

(30) Foreign Application Priority Data
Feb. 5, 2018 (KR) 10-2018-0013901

(51) Int. Cl. H04N 21/258; H04L 9/32

(52) U.S. Cl. CPC H04N 21/25816; H04L 9/3213; H04N 21/25875

(57) ABSTRACT

The present disclosure relates to an electronic device, an authentication device, and a control method therefor. The electronic device includes: a communicator configured to communicate with an authentication device; a storage configured to store data; and a processor configured to encrypt first authentication data by causing the authentication device to encrypt identification information on the electronic device and unique data of the authentication device to generate second authentication data, store the generated second authentication data in the storage, and transmit the stored second authentication data to the authentication device to request authentication of the electronic device. In this way, a CAS operator does not need to generate security keys for each electronic device and does not need to manage matching information between the electronic devices and the security keys. In addition, a manufacturer of the electronic device does not need to receive the security keys for each electronic device separately, and does not need to provide the CAS operator with usage history of the security keys for each electronic device.

### TECHNICAL FIELD

The present disclosure relates to an electronic device, an authentication device, and a control method thereof, and more particularly, to an electronic device for a conditional access system, an authentication device, and a control method thereof.

### BACKGROUND ART

A conditional access system (hereinafter, referred to as ‘CAS’) is a system that grants or restricts authority to watch paid broadcasts, and is a content security technology that allows users to watch only subscribed channels. In the CAS, it is necessary to authenticate an electronic device having a broadcast receiving function, such as a set-top box.

In the related art of authenticating the set-top box in the CAS, a CAS operator generates security keys for each set-top box. The CAS operator also manages matching information between the set-top box and the security key. For example, when the total number of set-top boxes to be manufactured by a manufacturer of a set-top box is notified to the CAS operator, the CAS operator generates the number of security keys as many as the number of set-top boxes and transmits the generated security keys to the manufacturer of the set-top box. Thereafter, when the security keys transmitted from the manufacturer of the set-top box are mounted in each set-top box, and then information (usage history of security key) on the security keys mounted in each set-top box is transmitted to the CAS operator, the CAS operator stores and manages the matching information on the security keys for each set-top box and uses the matching information to authenticate the set-top box in the future.

However, there are several problems with the related art. In order to safely transmit the security key generated by the CAS operator to the manufacturer of the set-top box and transmit the usage history of the security keys mounted in each set-top box from the manufacturer of the set-top box to the CAS operator, it is inconvenient to transmit and receive the security key and the usage history of the security key by a secure method, for example, by a transmission method by a security specialist in a location where security is secured. In addition, it is inconvenient for the CAS operator to generate a security key separately for each set-top box and store and manage the matching information between the set-top box and the security key. It is inconvenient for the manufacturer of the set-top box to receive a security key separately for each set-top box and to transmit usage history of each security key to the CAS operator.

### DISCLOSURE

### Technical Problem

Accordingly, the present disclosure is to provide an electronic device, an authentication device, and a system without generating security keys for each electronic device having a broadcast receiving function and managing matching information between the electronic devices and the security keys when a CAS operator authenticates the electronic devices, for example, a set-top box.

In addition, the present disclosure is to provide an electronic device, an authentication device, and a system in which a manufacturer of an electronic device does not need to receive security keys separately for each electronic device and provide a CAS operator with use history of security keys for each electronic device.

### Technical Solution

According to an aspect of the present disclosure, an electronic device includes: a communicator configured to communicate with an authentication device; a storage configured to store data; and a processor configured to encrypt first authentication data by causing the authentication device to encrypt identification information on the electronic device and unique data of the authentication device to generate second authentication data, store the generated second authentication data in the storage, and transmit the stored second authentication data to the authentication device to request authentication of the electronic device.

In this way, a manufacturer of the authentication device does not need to generate security keys for each electronic device, and does not need to manage matching information between individual electronic devices and the security keys, and as result, management convenience is increased. The manufacturer of the electronic device also does not need to receive security keys for each electronic device separately, and does not need to provide the usage history of the security keys for each electronic device to the manufacturer of the authentication device, and as a result, the management convenience is increased.

The processor may be configured to encrypt the identification information on the electronic device and transmit the encrypted identification information to the authentication device.

In this way, the authentication device can conveniently secure the identification information on the electronic device.

The second authentication data may further include the identification information on the electronic device.

In this way, when the electronic device that succeeds in the initial authentication again requests authentication later, the authentication can be performed more quickly.

According to another aspect of the present disclosure, an electronic device includes: a communicator configured to communicate with an authentication device; a storage configured to store second authentication data generated by encrypting first authentication data by causing the authentication device to encrypt identification information on the electronic device and unique data of the authentication device; and a processor configured to transmit the second authentication data stored in the storage to the authentication device to request authentication of the electronic device.

The second authentication data may further include the identification on the electronic device.

According to another aspect of the present disclosure, an authentication device includes: a communicator configured to communicate with an electronic device; and a processor configured to encrypt identification information on the electronic device and unique data of the authentication device to generate first authentication data, and transmit the generated first authentication data to the electronic device.

The processor may receive the identification information on the electronic device from the electronic device.

According to another aspect of the present disclosure, an authentication device includes: a communicator configured to communicate with an electronic device; and a processor configured to receive an authentication request of the electronic device and second authentication data from the electronic device, decrypt the received second authentication data to obtain identification information on the electronic device and unique data of the authentication device, and authenticate the electronic device based on the obtained identification information and unique data.

The authentication device may further include a storage configured to store the identification information on the electronic device, in which the processor may compare the obtained identification information with the identification information on the electronic device stored in the storage to authenticate the electronic device.

The authentication device may further include a storage configured to store the identification information on the electronic device and unique data corresponding to the identification information, in which the processor may compare the obtained identification information and unique data with the identification information on the electronic device and the unique data stored in the storage to authenticate the electronic device.

The second authentication data may further include the identification information on the electronic device, and the processor may be configured to store the identification information on the electronic device included in the second authentication data in the storage when the electronic device is successfully authenticated.

The processor may be configured to obtain the identification information on the electronic device from the second authentication data, and compare the obtained identification information on the electronic device with the identification information on the electronic device stored in the storage to authenticate the electronic device.

According to another aspect of the present disclosure, a control method of an electronic device that communicates with an authentication device includes: generating second authentication data by encrypting first authentication data by causing the authentication device to encrypt identification information on the electronic device and unique data of the authentication device; storing the generated second authentication data; and transmitting the stored second authentication data to the authentication device to request authentication of the electronic device.

The control method may further include encrypting the identification information on the electronic device and transmitting the encrypted identification information to the authentication device.

The second authentication data may further include the identification information on the electronic device.

According to another aspect of the present disclosure, a control method of an electronic device that communicates with an authentication device includes: generating first authentication data by encrypting identification information on the electronic device and unique data of the authentication device; and transmitting the generated first authentication data to the electronic device.

According to another aspect of the present disclosure, a control method of an authentication device that communicates with an electronic device includes: receiving an authentication request of the electronic device and second authentication data from the electronic device, decrypting the received second authentication data to obtain identification information on the electronic device and unique data of the authentication device, and authenticating the electronic device based on the obtained identification information and unique data.

In the authenticating, the obtained identification information may compare with the identification information on the electronic device stored in the storage to authenticate the electronic device.

The second authentication data may further include the identification information on the electronic device, and the control method may further include storing the identification information on the electronic device included in the second authentication data when the electronic device is successfully authenticated.

In the authenticating, the identification information on the electronic device may be obtained from the second authentication data, and the obtained identification information on the electronic device may compare with the identification information on the electronic device stored in the storage to authenticate the electronic device.

A computer program according to an embodiment of the present disclosure is a computer program stored in a medium to execute the control method by being combined with the electronic device.

The computer program may be stored in the medium in the server and may be downloaded to the electronic device through the network.

### Advantageous Effects

As described above, according to the present disclosure, the CAS operator does not need to generate the security keys for each electronic device and does not need to manage the matching information between the electronic devices and the security keys.

In addition, according to the present disclosure, the manufacturer of the electronic device does not need to receive the security keys for each electronic device separately, and does not need to provide the CAS operator with the usage history of the security keys for each electronic device.

### DESCRIPTION OF DRAWINGS

FIG. 1 is a diagram illustrating a system including an electronic device and an authentication device according to an embodiment of the present disclosure.

FIG. 2 is a diagram illustrating configurations of the electronic device and the authentication device according to the embodiment of the present disclosure.

FIG. 3 is a diagram illustrating operations of the electronic device and the authentication device according to the embodiment of the present disclosure.

FIG. 4 is a diagram illustrating data transmitted between the electronic device and the authentication device according to the embodiment of the present disclosure.

FIG. 5 is a diagram illustrating an operation of decrypting the authentication device according to the embodiment of the present disclosure.

FIG. 6 is a diagram illustrating an example of identification information on the electronic device and unique data of the authentication device that are stored in the authentication device according to the embodiment of the present disclosure.

FIG. 7 is a diagram illustrating operations of an electronic device and an authentication device according to another embodiment of the present disclosure.

FIG. 8 is a diagram illustrating operations of an electronic device and an authentication device according to still another embodiment of the present disclosure.

FIG. 9 is a diagram illustrating operations of an electronic device and an authentication device according to yet another embodiment of the present disclosure.

### MODE FOR DISCLOSURE

Hereinafter, embodiments of the present disclosure will be described in detail with reference to the accompanying drawings. In the drawings, the same reference numbers or signs refer to components that perform substantially the same function, and the size of each component in the drawings may be exaggerated for clarity and convenience. However, the technical idea and the core configuration and operation of the present disclosure are not limited only to the configuration or operation described in the following examples. In describing the present disclosure, if it is determined that a detailed description of the known technology or configuration related to the present disclosure may unnecessarily obscure the subject matter of the present disclosure, the detailed description thereof will be omitted.

In embodiments of the present disclosure, terms including ordinal numbers such as first and second are used only for the purpose of distinguishing one component from other components, and singular expressions include plural expressions unless the context clearly indicates otherwise. Also, in embodiments of the present disclosure, it should be understood that terms such as ‘configured’, ‘include’, and ‘have’ do not preclude the existence or addition possibility of one or more other features or numbers, steps, operations, components, parts, or combinations thereof. In addition, in the embodiment of the present disclosure, a ‘module’ or a ‘unit’ performs at least one function or operation, and may be implemented in hardware or software, or a combination of hardware and software, and may be integrated into at least one module and implemented as at least one processor. In addition, in embodiments of the present disclosure, at least one of the plurality of elements refers to not only all of the plurality of elements, but also each one or all combinations thereof excluding the rest of the plurality of elements. A term “configured (or set) to” may not necessarily mean only “specifically designed to” in hardware. Instead, in some cases, an expression “a device configured to” may mean that the apparatus may “do” along with other apparatuses or components. For example, a “processor configured (or set) to perform A, B, and C” may mean a dedicated processor (for example, an embedded processor) for performing the corresponding operations or a generic-purpose processor (for example, a central processing unit (CPU) or an application processor) that may perform the corresponding operations by executing one or more software programs stored in a memory apparatus.

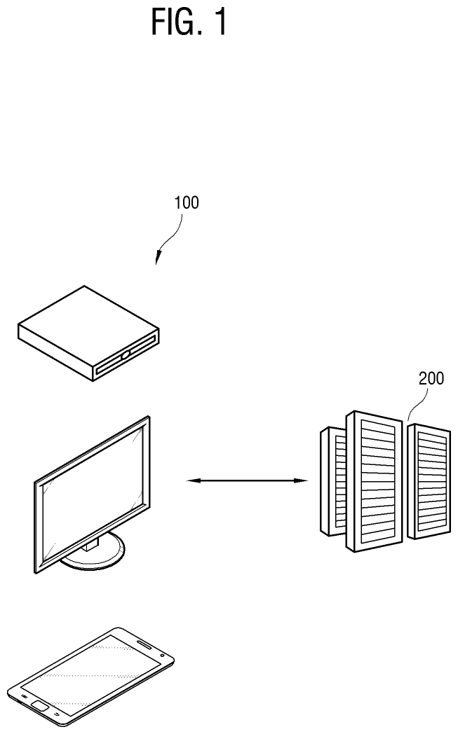

FIG. 1 illustrates a system including an electronic device 100 and an authentication device 200 according to an embodiment of the present disclosure.

The electronic device 100 according to the embodiment of the present disclosure may be implemented as, for example, a broadcast receiving device or a set-top box. In addition, the electronic device 100 according to another embodiment of the present disclosure may be implemented as a display device including a display unit, for example, wearable devices such as a smartphone, a mobile phone, a smart watch, and a head-mounted display, and devices such as a computer, a multimedia player, an electronic frame, a digital billboard, a large format display (LFD), and a digital signage. However, the electronic device 100 according to the embodiment of the present disclosure is not limited thereto, and any device capable of transmitting and receiving data to and from the authentication device 200 can be used.

The authentication device 200 according to the embodiment of the present disclosure may be implemented as, for example, a server. However, as the authentication device 200 according to the embodiment of the present disclosure, any device capable of transmitting and receiving data to and from the electronic device 100 and performing authentication of the electronic device 100 can be used regardless of its name or form.

Summarizing the operations of the electronic device 100 and the authentication device 200 according to the embodiment of the present disclosure, the electronic device 100 requests authentication of the electronic device 100 to the authentication device 200, and the authentication device 200 determines whether or not to authenticate the electronic device 100 and performs processing according to the determination. Details will be described later.

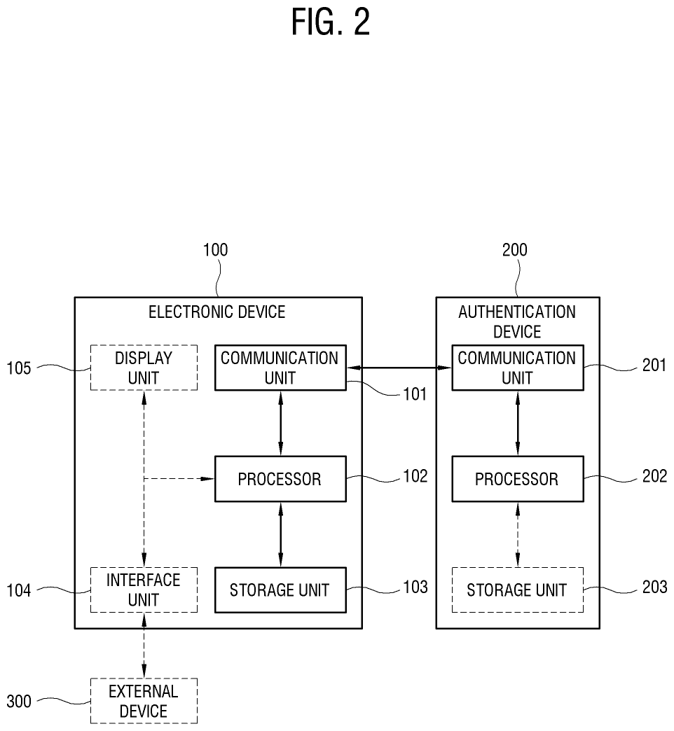

FIG. 2 illustrates a configuration of a system including the electronic device 100 and the authentication device 200 according to the embodiment of the present disclosure.

The electronic device 100 according to the embodiment of the present disclosure includes a communication unit 101, a processor 102, and a storage unit 103. The authentication device 200 according to the embodiment of the present disclosure includes a communication unit 201 and a processor 202. However, the configurations of the electronic device 100 and the authentication device 200 illustrated in FIG. 2 are only one example, and the electronic device 100 and the authentication device 200 according to the embodiment of the present disclosure may be implemented as another configuration. That is, the electronic device 100 and the authentication device 200 according to the embodiment of the present disclosure may be implemented by adding other components in addition to the components illustrated in FIG. 2 or by excluding a part of the components illustrated in FIG. 2. For example, the electronic device 100 according to the embodiment of the present disclosure may further include an interface unit 104 to transmit and receive a signal to and from an external device 300, and may further include a display unit 105. The authentication device 200 according to the embodiment of the present disclosure may further include the storage unit 203.

The communication unit 101 of the electronic device 100 as a communicator may communicate with the authentication device 200. The communication unit 101 may perform communication in a wired or wireless manner. Therefore, communications can be implemented in various other communication schemes in addition to connection units including a connector or a terminal for wired connection. For example, the communication unit 101 may be configured to perform one or more communications among Wi-Fi, Bluetooth, Zigbee, infrared communication, radio control, ultra-wide band (UWM), wireless USB, and near field communication (NFC). The communication unit 101 may include a communication module such as an Ethernet module, Bluetooth low energy (BLE), serial port profile (SPP), WiFi direct, infrared communication, Zigbee, and near field communication (NFC). The communication unit 101 may be implemented in the form of a S/W module, a circuit, and a chip.

The processor 102 of the electronic device 100 may process data received by the communication unit 101. For example, the processor 102 may encrypt data or decrypt the encrypted data.

The processor 102 may perform control to operate the overall components of the electronic device 100. The processor 102 may include control programs (or instructions) for performing the control operation, a non-volatile memory in which control programs are installed, a volatile memory in which at least a part of the installed control programs is loaded, and at least one processor or a central processing unit (CPU) in which the loaded control programs are executed. In addition, such a control program may also be stored in electronic devices other than the electronic device 100.

The control program may include a program(s) implemented in at least one of a BIOS, a device driver, an operating system, firmware, a platform, and an application program (application). As an embodiment, the application program may be pre-installed or pre-stored in the electronic device 100 at the time of manufacturing of the electronic device 100, or may be installed in the electronic device 100 based on data of the application program received from the outside when used later. The data of the application program may be downloaded from the external server, such as an application market, to the electronic device 100, but is not limited thereto. Meanwhile, the processor 102 may be implemented in the form of a device, a S/W module, a circuit, and a chip, or a combination thereof.

The processor 102 may control the communication unit 101 to receive data, for example. The processor 102 may also control the communication unit 101 to transmit data to the authentication device 200. The electronic device 100 illustrated in FIG. 2 is implemented as a configuration that performs processing and control together in one processor 102, which is only an example, and the electronic device 100 according to another embodiment of the present disclosure may be implemented in a configuration further including a processing unit or a control unit separately from the processor.

The storage unit 103 of the electronic device 100 as a storage may store data received through the communication unit 101 or data processed by the processor 102. The storage unit 103 may store various data according to the processing and control of the processor 102. The storage unit 103 may be accessed by the processor 102 to read, record, modify, delete, update, and the like data. The storage unit 103 may include non-volatile memories such as a flash-memory, a hard-disc drive, and a solid-state drive (SSD) so that data can be stored regardless of whether or not system power is provided to the electronic device 100. In addition, the storage unit 103 may include volatile memories such as a buffer and RAM for temporarily loading data processed by the processor 102.

The electronic device 100 according to the embodiment of the present disclosure may further include the interface unit 104 to transmit and receive a signal to and from the external device 300. For example, the electronic device 100 may transmit and receive a video signal or an audio signal between an external display device, a speaker, and the like through the interface unit 104. The interface unit 104 may adopt an interface system such as HDMI, DP, RGB, DVI, and thunderbolt, but the interface system is not limited thereto.

The electronic device 100 according to the embodiment of the present disclosure may further include the display unit 105. The display unit 105 may display processing results of the processor 102. The implementation scheme of the display unit 105 is not limited, and the display unit 103 may be implemented in various display schemes such as liquid crystal, plasma, a light-emitting diode, an organic light-emitting diode, surface-electron gun conduction electron-emitter, carbon nano-tube, and nano-crystal. In the case of the liquid crystal scheme, the display unit 105 includes a liquid crystal display panel, a backlight unit that supplies light to the liquid crystal display panel, a panel driving unit that drives the liquid crystal display panel, and the like. The display unit 105 may be implemented as an OLED panel that is a self-luminous element without a backlight unit.

The authentication device 200 according to the embodiment of the present disclosure includes the communication unit 201 and the processor 202. All the descriptions of the communication unit 101 and the processor 102 of the electronic device 100 can be applied to the functions and configurations of the communication unit 201 and the processor 202 of the authentication device 200, and therefore a detailed description thereof will be omitted.

The authentication device 200 according to the embodiment of the present disclosure may further include the storage unit 203. All the descriptions of the storage unit 103 of the electronic device 100 can be applied to the function and configuration of the storage 203 of the authentication device 200, and therefore a detailed description thereof will be omitted.

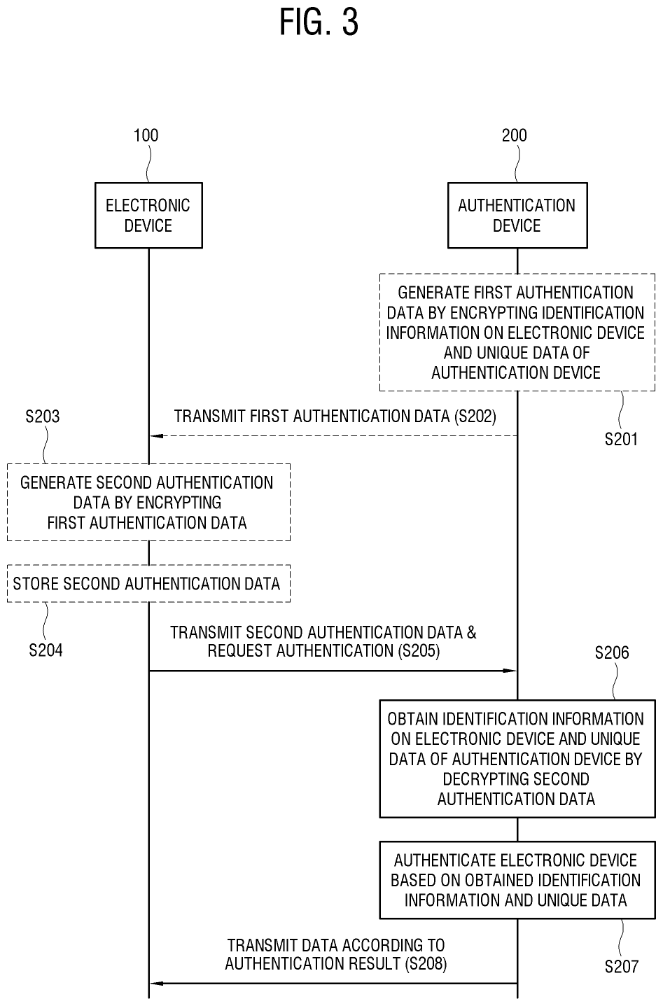

FIG. 3 illustrates the operations of the electronic device 100 and the authentication device 200 according to the embodiment of the present disclosure.

The processor 202 of the authentication device 200 according to the embodiment of the present disclosure encrypts identification information on the electronic device and unique data of the authentication device to generate first authentication data (S301).

Here, the first authentication data is data generated by the authentication device 200 or a manufacturer of an authentication device, an affiliated company of an authentication device, an operator of an authentication device, and the like (hereinafter, collectively referred to as ‘manufacturer of authentication device’), and refers to data that can verify the reliability in the authentication device 200. For example, the first authentication data may be data encrypted with the public key according to an encryption algorithm using an asymmetric key of a public key-private key pair by the processor 202 of the authentication device 200. In this case, the processor 202 of the authentication device 200 can verify reliability of data by decrypting the data using the private key, and only the authentication device 200 can verify the reliability unless the private key corresponding to the public key is leaked. However, the form of the first authentication data is not limited thereto.

Further, the first authentication data is information that encrypts the identification information on the electronic device and the unique data of the authentication device. Here, the electronic device is a concept that can include a plurality of electronic devices as an upper concept of the electronic device. For example, the electronic device may mean the manufacturer of the electronic device. Therefore, the identification information on the electronic device may be identification information corresponding to a plurality of electronic devices 100, for example, identification information corresponding to the manufacturer of the electronic device 100. However, the identification information on the electronic device is not limited to identification information corresponding to the manufacturer of the electronic device. For example, the identification information on the electronic device may be independent of the manufacturer of the electronic device, or identification information on a plurality of electronic devices may be supported for one manufacturer even if the identification information relates to the manufacturer of the electronic device.

The unique data of the authentication device is data generated by the authentication device to correspond to the identification information on the electronic device, and is data that can be used while the authentication device 200 authenticates the electronic device 100. There is no particular limitation on the contents and format of the unique data, and any data that is generated to correspond to the identification information on the electronic device and can be used in the authentication process of the electronic device 100 is possible. An authentication method of the electronic device 100 using the first authentication data, for example, a method of authenticating the electronic device 100 using the identification information on the electronic device and the unique data of the authentication device will be described later.

The processor 202 of the authentication device 200 transmits the generated first authentication data to the electronic device 100 (S302). The processor 202 of the authentication device 200 may transmit the first authentication data to the communication unit 101 of the electronic device 100 through the communication unit 201. In this case, the above communication may be performed through a general public communication network, or through a dedicated communication network to secure enhanced security. In addition, communication may be performed after a separate encryption measure to secure security during transmission.

The processor 102 of the electronic device 100 receiving the first authentication data from the authentication device 200 encrypts the first authentication data to generate second authentication data (S303).

Here, the second authentication data is data transmitted from the electronic device 100 to the authentication device 200 for the authentication of the electronic device 100, and is information that serves as security keys for each electronic device 100. The second authentication data may be directly generated by the processor 102 of the electronic device 100 and stored in the electronic device 100, or may be generated outside the electronic device and then stored in the storage unit 103 of the electronic device 100.

The second authentication data includes the first authentication data. For example, the second authentication data may be generated by encrypting the first authentication data to include the first authentication data. For example, the processor 102 of the electronic device 100 may generate the second authentication data by encrypting the first authentication data with a private key among asymmetric encryption keys allocated for the electronic device. In this case, the processor 102 of the electronic device 100 may transmit the generated second authentication data to the authentication device 200 along with the public key corresponding to the above private key, and the processor 202 of the authentication device 200 that receives the second authentication data and the public key may decrypt the second authentication data received by the received public key to verify that the second authentication data is encrypted by the electronic device 100. However, the form in which the second authentication data includes the first authentication data or the method of encrypting the first authentication data is not limited thereto. A specific method of authenticating the electronic device 100 using the second authentication data will be described later.

The first authentication data and/or the second authentication data may be implemented in the form of the X.509 standard certificate. However, the implementation form of the authentication data and the specification of the certificate are not limited thereto.

The processor 102 of the electronic device 100 that generates the second authentication data stores the generated second authentication data in the storage unit 103 (S304). In this way, when the authentication of the electronic device 100 is required later, the processor 102 of the electronic device 100 reads the second authentication data stored in the storage unit 103 and transmits the read second authentication data to the authentication device 200 to request the authentication.

The above embodiment describes an operation in which the first authentication data is generated in the authentication device 200 and is transmitted from the authentication device 200 to the electronic device 100 so that the electronic device 100 receiving the first authentication data encrypts the first authentication data and generates and stores the second authentication data, but the embodiment of the present disclosure is not limited thereto. For example, the first authentication data is not generated in the authentication device 200 but may be generated in other devices. In addition, the generated first authentication data is not transmitted from the authentication device 200 to the electronic device 100, but may be transmitted by another method or through another path, for example, by a transmission method by a security specialist in a location where security is secured. In this case, the first authentication data may not be transmitted between the authentication device 200 and the electronic device 100, but may be transmitted between the manufacturer of the authentication device and the manufacturer of the electronic device. In addition, instead of the method in which the electronic device 100 directly generates and stores the second authentication data, the manufacturer of the electronic device may generate the second authentication data and then mount the generated second authentication data in the electronic device 100.

When the second authentication data is stored in the storage unit 103 of the electronic device 100 through at least one of the various methods described above, the processor 102 of the electronic device 100 may transmit the second authentication data to the authentication device 200 to request the authentication of the electronic device 100 (S305). All the descriptions of the specific method of transmitting the first authentication data from the authentication device 200 to the electronic device 100 described above can be applied to a detailed method of transmitting the second authentication data from the electronic device 100 to the authentication device 200, and therefore a detailed description thereof will be omitted.

The processor 202 of the authentication device 200 receiving the second authentication data from the electronic device 100 decrypts the second authentication data to obtain the identification information on the electronic device and the unique data of the authentication device (S306). For example, the second authentication data is generated by encrypting the first authentication data with the private key among the asymmetric encryption keys allocated to the electronic device 100, and when the electronic device 100 transmits the public key corresponding to the private key to the authentication device 200 along with the second authentication data, the processor 202 of the authentication device 200 may decrypt the received second authentication data with the received public key. However, the decryption method is not limited thereto.

By decrypting the second authentication data, the processor 202 of the authentication device 200 may obtain the first authentication data included in the second authentication data. The processor 202 of the authentication device 200 that has obtained the first authentication data may decrypt the first authentication data again to further obtain the identification information on the electronic device and the unique data of the authentication device. For example, when the first authentication data is encrypted with the public key corresponding to the authentication device 200, the processor 202 of the authentication device 200 may decrypt the first authentication data with the private key corresponding to the public key to obtain the identification information on the electronic device included in the first authentication data and the unique data of the authentication device. However, the method of decrypting the first authentication data is not limited thereto.

The processor 202 of the authentication device 200 that obtains the identification information on the electronic device and the unique data of the authentication device authenticates the electronic device 100 based on the obtained identification information and unique data (S307), and transmits data to the electronic device 100 according to the authentication result (S308).

As an example of a specific method of authenticating the electronic device 100 based on the obtained identification information and unique data, the processor 202 of the authentication device 200 checks whether or not the electronic device 100 requesting the authentication is an electronic device that is qualified to receive the first authentication data based on the obtained identification information on the electronic device. As an example of the checking method, the processor 202 of the authentication device 200 may compare the obtained identification information with a list of pre-stored identification information on the electronic device to check whether or not the electronic device 100 requesting the authentication is an electronic device that is qualified to receive the first authentication data when the obtained identification information corresponds to at least one of the above list.

Various methods are available for the authentication device (200) to obtain a list of the identification information on the electronic device. For example, when the identification information on the electronic device corresponds to the manufacturer of the electronic device, a list of the manufacturers of the electronic device that is qualified to receive the first authentication data is directly provided from a trusted third party, so a list of the identification information corresponding to manufacturers of each electronic device may be stored in the storage unit 203 of the authentication device 200. Alternatively, the authentication device 200 may receive the identification information on the electronic device from each electronic device 100 through a communication network and store the identification information in the storage unit 203. In addition, any method that can secure a list of the identification information on the trusted electronic device can be used without being limited.

As described above, by comparing the identification information on the electronic device pre-stored in the authentication device 200 with the identification information obtained by again decrypting the first authentication data that decrypts the received second authentication data, the reliability of the electronic device 100 requesting the authentication is primarily checked, and then the processor 202 of the authentication device 200 may more reliably check the reliability of the electronic device 100 requesting the authentication based on the obtained unique data. However, additional authentication based on the unique data is not always required, and the authentication of the electronic device 100 may be possible only by checking reliability based on the identification information on the electronic device.

Since the processor 202 of the authentication device 200 generates the unique data so that the unique data corresponds to the identification information on each electronic device, the processor 202 of the authentication device 200 may utilize the matching information between the unique data generated by the authentication device for the identification information on the electronic device in order to authenticate the electronic device 100. In other words, since the authentication device 200 may store information on what unique data is generated for the identification information on each electronic device, it is checked whether or not the information on the identification information and the unique data in the first authentication data obtained by decrypting the received second authentication data matches the matching information between the identification information on the electronic device and the unique data that the authentication device 200 stores and manages to check whether or not the second authentication data is generated based on the first authentication data generated by the authentication device 200.

As a result, the second authentication data serving as the security keys for each electronic device is directly generated by each electronic device or the electronic device based on the first authentication data generated by the manufacturer of the authentication device so that the first authentication data corresponds to the electronic device, so it is sufficient for the authentication device to generate and manage authentication data in units of the identification information on the electronic device. That is, the authentication device does not need to manage authentication data for each electronic device. It is sufficient that the electronic device is authenticated by individually transmitting the security keys for each electronic device to the authentication device, and as a result, it is not necessary to transmit the usage history of the security keys for all the electronic devices to the authentication device. Therefore, the manufacturer of the authentication device does not need to generate security keys for each electronic device, and does not need to manage the matching information between individual electronic devices and the security keys, and as result, the management convenience is increased. The manufacturer of the electronic device also does not need to receive security keys for each electronic device separately, and does not need to provide the usage history of the security keys for each electronic device to the manufacturer of the authentication device, and as a result, the management convenience is increased.

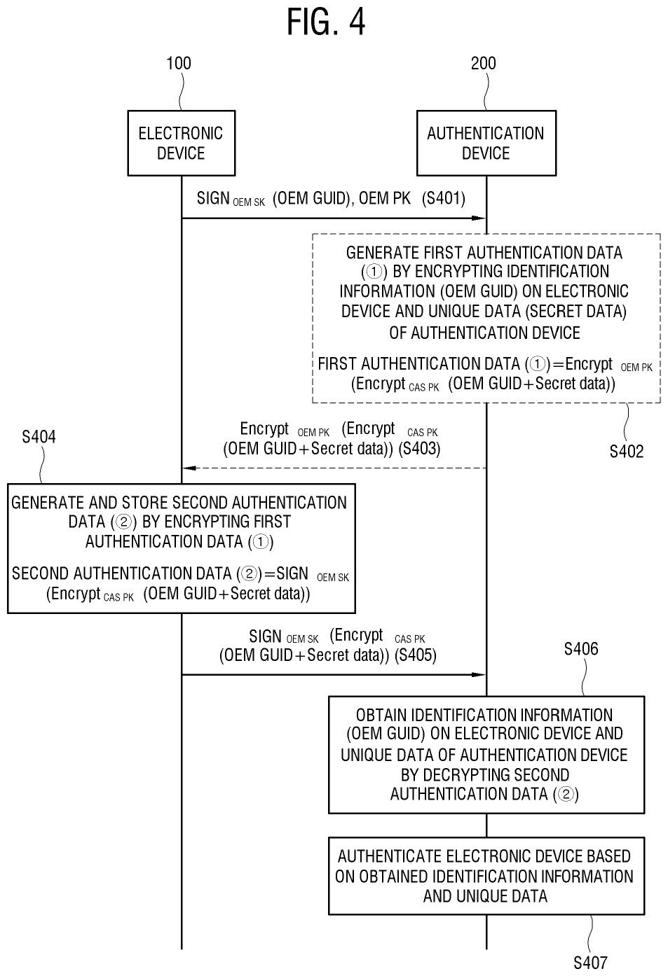

FIG. 4 illustrates data transmitted between the electronic device 100 and the authentication device 200 according to the embodiment of the present disclosure. An example of the form of the first authentication data and the second authentication data and a method of encrypting and decrypting each of the first authentication data and the second authentication data will be described in detail with reference to FIG. 4. FIG. 4 illustrates an example of using an RSA encryption algorithm using an asymmetric key between a private key (hereinafter, referred to as ‘SK’) and a public key (hereinafter, referred to as ‘PK’) as an encryption and decryption method, but the encryption and decryption method of the present disclosure is not limited thereto.

It will be described on the assumption that when OEM PK and OEM SK are generated with the public key and the private key corresponding to the manufacturer of the electronic device or the electronic device, respectively, and CAS PK and CAS SK are generated with the public key and the private key corresponding to the manufacturer of the authentication device or the authentication device, respectively, the corresponding public key OEM PK and private key OEM SK on the electronic device are provided to the electronic device 100, and the public key CAS PK and private key CAS SK corresponding to the authentication device are provided in the authentication device 100.

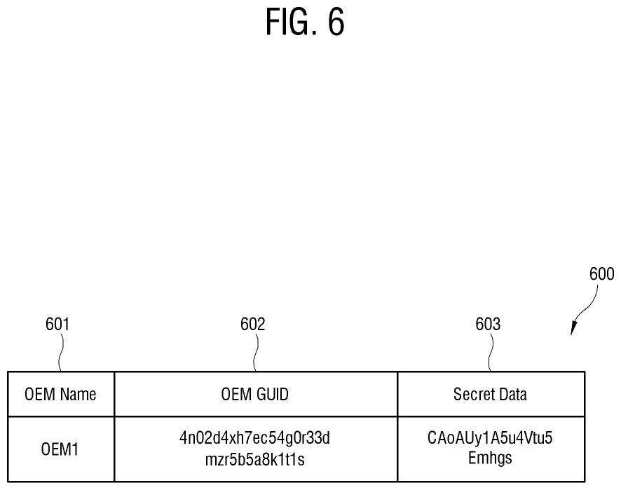

The processor 102 of the electronic device 100 encrypts OEM globally unique identifier (OEM GUID), which is the identification information on the electronic device, with the OEM SK which is the private key on the electronic device, and then transmits the OEM GUID to the authentication device 200 along with the OEM PK which is a public key on the electronic device (S401). Here, the OEM GUID is information uniquely allocated to the manufacturer of each electronic device, and as illustrated in FIG. 6, the OEM GUIDE may be, for example, any character string of 32 digits in which numbers and English characters are mixed (602). However, types and lengths of the characters constituting the OEM GUID are not limited thereto, and any information capable of distinguishing the manufacturers of the electronic device can be used. In addition, the OEM GUID may further include or correspond to information 601 on the name of the manufacturer of the electronic device.

The processor 202 of the authentication device 200 that receives the OEM GUID encrypted with the private key on the electronic device may obtain the OEM GUID by decrypting the encrypted information through the OEM PK received along with the encrypted OEM GUID, and at the same time, can check that the information is encrypted by an object corresponding to the above OEM PK, that is, the manufacturer of the electronic device. The processor 202 of the authentication device 200 may receive the OEM PK through a third-party authentication authority to further secure that the OEM PK received by the processor 202 is not hacked.

On the other hand, the embodiment in which the authentication device 200 receives the identification information on the electronic device from the electronic device 100 as described above by the method for the authentication device 200 to secure the identification information on the electronic device is described with reference to FIG. 4. In this way, the authentication device can conveniently secure the identification information on the electronic device. However, as described above, the method for the authentication device 200 to secure the identification information on the electronic device is not limited thereto.

The processor 202 of the authentication device 200 that has obtained the OEM GUID adds the OEM GUID to the list of the identification information on the electronic device stored and managed by the authentication device 200, and as a result, may be used to check whether or not the electronic device 100 is manufactured by the manufacturer of the electronic device checked or approved by the authentication device 200 when the electronic device 100 is authenticated.

The processor 202 of the authentication device 200 that has obtained the OEM GUID generates secret data, which is the unique data of the authentication device corresponding to the OEM GUID.

Here, the secret data is information uniquely generated by the processor 202 of the authentication device 200 and information corresponding to the OEM GUID, and as illustrated in FIG. 6, the secret data may be, for example, any character string of 20 digits in which numbers and English uppercase and lowercase letters are mixed (603). However, types of the characters and lengths of the character string constituting the secret data are not limited thereto, and any information that can be corresponded differently for each OEM GUID can be used.

The processor 202 of the authentication device 200 that has generated the secret data may store secret data generated by itself and matching information of the OEM GUID corresponding thereto. The secret data and the matching information of the OEM GUID corresponding thereto are information indicating the correspondence between the secret data and the OEM GUID, and may be, for example, table type data as illustrated in FIG. 6 (600). The processor 202 of the authentication device 200 utilizes the stored matching information later when authenticating the electronic device 100 to check whether or not the second authentication data received from the electronic device 100 to be authenticated is based on the first authentication data generated by the authentication device 200 and authenticate the electronic device 100 based on the checked result.

The processor 202 of the authentication device 200 that obtains the OEM GUID as the identification information on the electronic device, and generates the secret data which is the unique data corresponding thereto encrypts the OEM GUID and the secret data to generate the first authentication data (S402). For example, the processor 202 of the authentication device 200 may generate the first authentication data by the method of encrypting the OEM GUID and secret data using the CAS PK which is the public key on the authentication device. In this case, only the authentication device 200 that knows the CAS SK which is the private key corresponding to the CAS PK may decrypt the first authentication data later to check the first authentication data. Furthermore, the processor 202 of the authentication device 200 may encrypt the first authentication data with the OEM PK once more so that the first authentication data is not hacked while the first authentication data is transmitted to the electronic device 100. In this case, only the manufacturer of the electronic device or the electronic device 100 that knows the OEM SK which is the private key corresponding to the OEM PK may obtain the encrypted first authentication data. The data generated through the above process, that is, the data obtained by encrypting the first authentication data with the OEM PK is expressed as follows.

Encrypt_{OEM PK}(Encrypt_{CAS PK}(OEM GUID+Secret data))

The processor 202 of the authentication device 200 transmits the first authentication data or data obtained by encrypting the first authentication data again to the electronic device 100 (S403).

The processor 102 of the electronic device 100 that receives the first authentication data or data obtained by encrypting the first authentication data encrypts the first authentication data and the data to generate the second authentication data and store the generated second authentication data in the storage unit 103 (S404).

An example of a method in which the processor 102 of the electronic device 100 encrypts the first authentication data to generate the second authentication data is a method in which data, which is encrypted with the OEM PK, with the OEM SK is decrypted to obtain the first authentication data and then encrypt the obtained first authentication data with the OEM SK in order to prevent hacking during transmission, thereby indicating that the above data is data obtained by encrypting the first authentication data by the processor 102 of the electronic device 100. The second authentication data generated through the above process is expressed as follows.

SIGN_{OEM SK}(Encrypt_{CAS PK}(OEM GUID+Secret data))

However, the second authentication data is not limited thereto, and unlike the above example in which only the first authentication data is additionally encrypted with the OEM SK, the second authentication data may be data obtained by adding additional information of other contents to the first authentication data and then encrypting the authentication data with the additional information. Alternatively, the second authentication data may be the same data as the first authentication data.

The processor 102 of the electronic device 100 transmits the second authentication data to the authentication device 200 to request the authentication (S405).

The processor 202 of the authentication device 200 receiving the second authentication data from the electronic device 100 decrypts the second authentication data to obtain the identification information on the electronic device and the unique data of the authentication device (S406).

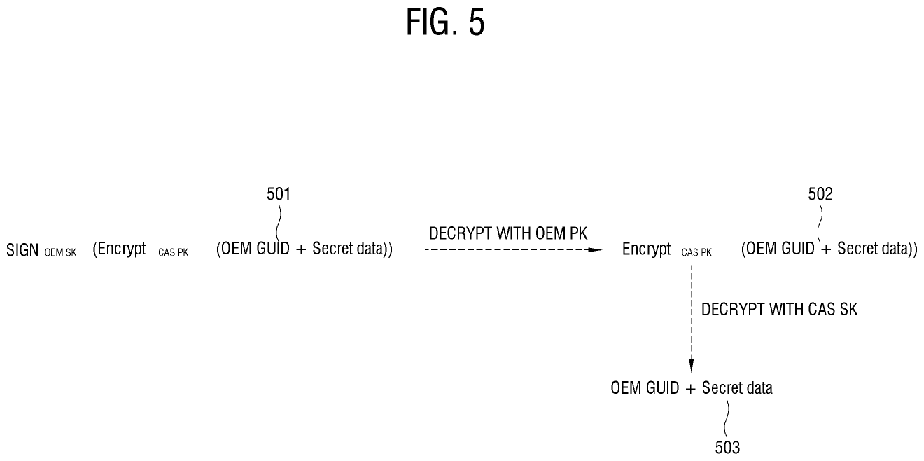

A detailed method of obtaining the identification information on the electronic device and the unique data of the authentication device by decrypting the second authentication data illustrated in FIG. 4 will be described with reference to FIG. 5.

The processor 202 of the authentication device 200 that receives second authentication data 501 may decrypt the second authentication data 501 with the OEM PK which is the public key on the electronic device previously received from the electronic device 100 to obtain first authentication data 502.

Since the first authentication data 502 thus obtained is encrypted with the CAS PK which is the public key on the authentication device, the processor 202 of the authentication device 200 may decrypt the first authentication data with the CAS SK, which is the private key on the authentication device provided in the authentication device 200, to obtain the OEM GUID which is the identification information on the electronic device included in the first authentication data 502 and the secret data which is the unique data of the authentication device.

Referring back to FIG. 4, the processor 202 of the authentication device 200 that has obtained the OEM GUID as the identification information and the secret data as the unique data through the above process authenticates the electronic device 100 based on the obtained identification information and unique data (S407).

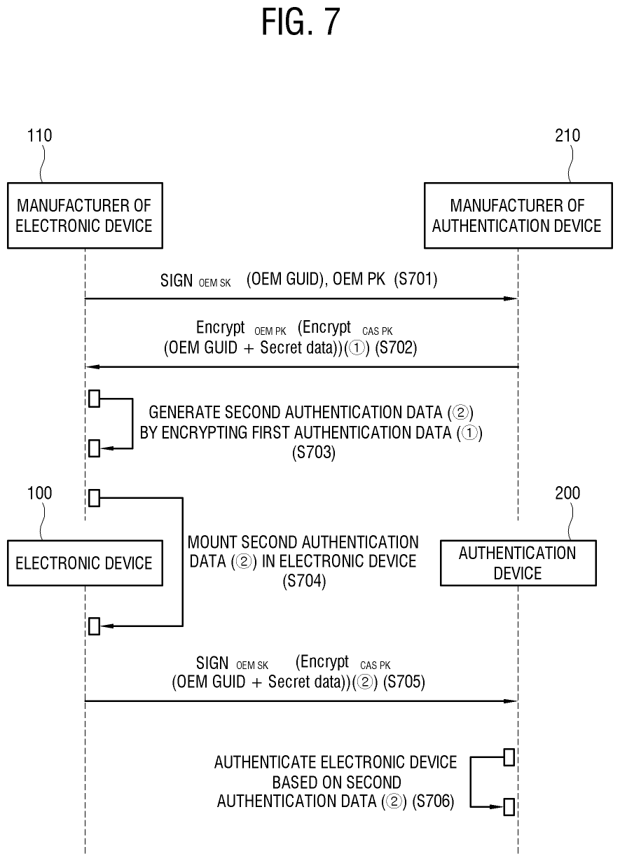

The above embodiment describes an operation in which the first authentication data is generated in the authentication device 200 and is transmitted from the authentication device 200 to the electronic device 100 so that the electronic device 100 receiving the first authentication data encrypts the first authentication data and generates and stores the second authentication data, but the embodiment of the present disclosure is not limited thereto. According to another embodiment of the present disclosure, the first authentication data may not be transmitted between the authentication device 200 and the electronic device 100, but may be transmitted between the manufacturer of the authentication device and the manufacturer of the electronic device, and the second authentication data may be generated by the manufacturer of the electronic device and mounted in the electronic device 100. In other words, the second authentication data may be stored in advance in the storage unit 103 of the electronic device 100. This will be described with reference to FIG. 7.

According to another embodiment of the present disclosure, a manufacturer 110 of the electronic device encrypts the OEM globally unique identifier (OEM GUID), which is the identification information on the electronic device, with the OEM SK which is the private key of the electronic device, and then transmits the encrypted OEM GUID to the manufacturer 210 of the authentication device 210 along with the OEM PK which is a public key on the electronic device (S701).

The manufacturer 210 of the authentication device receiving the OEM GUID encrypted with the private key on the electronic device generates the secret data, which is the unique data of the authentication device corresponding to the OEM GUID, and encrypts the OEM GUID and the secret data to perform the first authentication data. Thereafter, the generated first authentication data is transmitted to the manufacturer of the electronic device (S702).

In the above, since the data transmission between the manufacturer 110 of the electronic device and the manufacturer 210 of the authentication device is not transmission between the devices, but is transmission between the manufacturers, the data may be transmitted by the transmission method by a security specialist in a location where security is secured. However, the transmission using a public or dedicated communication network is not excluded.

The manufacturer 110 of the electronic device that receives the first authentication data from the manufacturer 210 of the authentication device encrypts the first authentication data to generate the second authentication data (S703) and mounts the generated second authentication data in each electronic device 100 (S704).

Through the above process, the electronic device 100 in which the second authentication data is mounted may transmit the mounted second authentication data to the authentication device 200 and request the authentication (S705), and the authentication device 200 receiving the data and the request performs the authentication of the electronic device 100 based on the received second authentication data (S706). That is, the operation of the electronic device 100 and the authentication device 200 after the second authentication data is mounted is the same as the operation in the embodiment described with reference to FIGS. 3 and 4 above.

In this way, the generation subject and transmission method of the authentication data become more diverse.

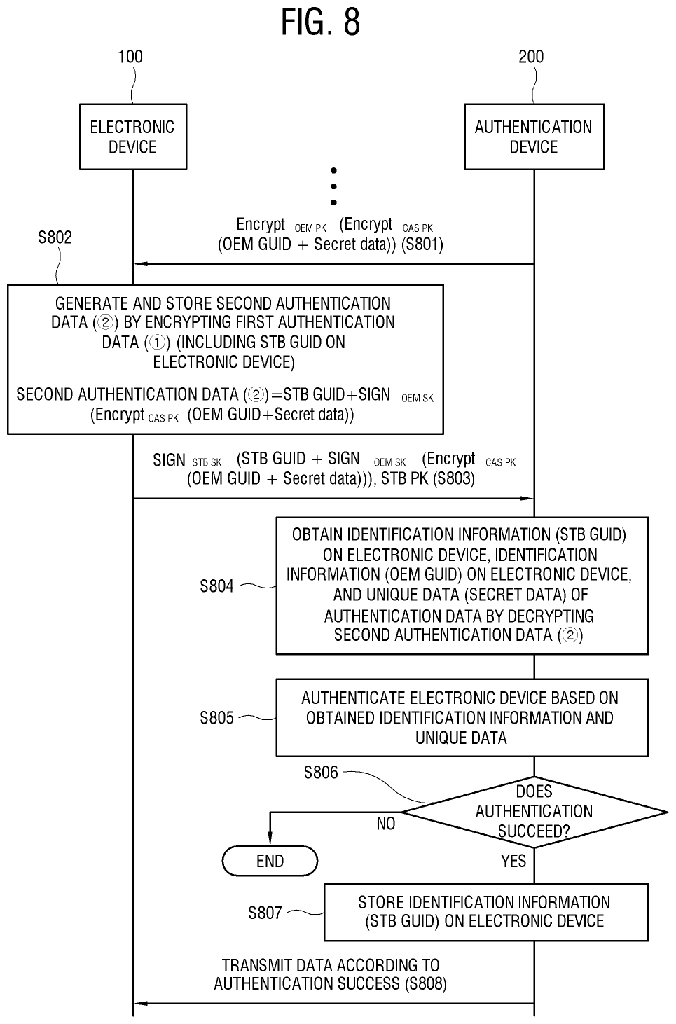

According to another embodiment of the present disclosure, the second authentication data may further include the identification information on the electronic device 100. This will be described with reference to FIG. 8. FIG. 8 illustrates an embodiment in which the second authentication data is generated by the processor 202 of the electronic device 100. However, as described above, the generation subject of the second authentication data is not limited thereto.

When the electronic device 100 receives the first authentication data from the authentication device 200 (S801), the processor 102 of the electronic device 100 encrypts the first authentication data to generate the second authentication data and stores the generated second authentication data in the storage unit 103 (S802). However, in the embodiment of FIG. 8, unlike the embodiment of FIG. 4 in which the first authentication data is directly encrypted, the processor 102 of the electronic device 100 encrypts the information in which the STB GUID, which is the identification information on the electronic device, is added to the first authentication data to generate the second authentication data. Here, the STB GUID is information uniquely allocated to each electronic device, and as in the OEM GUID 602 of FIG. 6, the OEM GUIDE may be, for example, any character string of 32 digits in which numbers and English characters are mixed. However, types and lengths of the character strings constituting the STB GUID are not limited thereto, and any information capable of distinguishing each electronic device can be used.

For example, the processor 102 of the electronic device 100 according to the present embodiment may generate, as the second authentication data, information in which the STB GUID is added to the second authentication data in the embodiment of FIG. 4 described above. An example of the second authentication data is expressed as follows.

STB GUID+SIGN_{OEM SK}(Encrypt_{CAS PK}(OEM GUID+Secret data))

The processor 102 of the electronic device 100 transmits the second authentication data to the authentication device 200 to request the authentication. To reduce the possibility of hacking in the process of transmitting the second authentication data, the processor 102 of the electronic device 100 may encrypt the second authentication data once more with the STB SK which is the private keys that are differently allocated to each electronic device, and transmit the encrypted second authentication data to the authentication device 200 along with the STB PK which is the public key corresponding to the STB SK (S803).

The processor 202 of the authentication device 200 receiving the second authentication data from the electronic device 100 decrypts the second authentication data to obtain the OEM GUID which is the identification information on the electronic device and the secret data which is the unique data of the authentication device and furthermore, acquire the STB GUID which is the identification information on the electronic device (S804). For example, when the second authentication data is encrypted with the STB SK, the processor 202 of the authentication device 200 may decrypt the second authentication data with the STB PK received along with the second authentication data to obtain the STB GUID. In addition, the method of obtaining the OEM GUID and the secret data through the decryption can equally be applied to the method described through FIG. 5 described above.

The processor 202 of the authentication device 200 that has obtained the OEM GUID as the identification information and the secret data as the unique data through the above process authenticates the electronic device 100 based on the obtained identification information and unique data (S805).

When the authentication is successful, unlike the embodiment of FIG. 3 or 4, which directly transmits data according to the authentication result to the electronic device 100, according to the present embodiment, when the authentication is successful (S806), the processor 202 of the authentication device 200 stores the STB GUID, which is the identification information on the corresponding electronic device, in the storage unit 203 (S806) and then transmits the data according to the authentication result to the electronic device 100 (S808). That is, the processor 202 of the authentication device 200 according to the present embodiment stores the list of the STB GUID, which is a list of the identification information on the electronic device 100 that is successfully authenticated, in the storage unit 203.

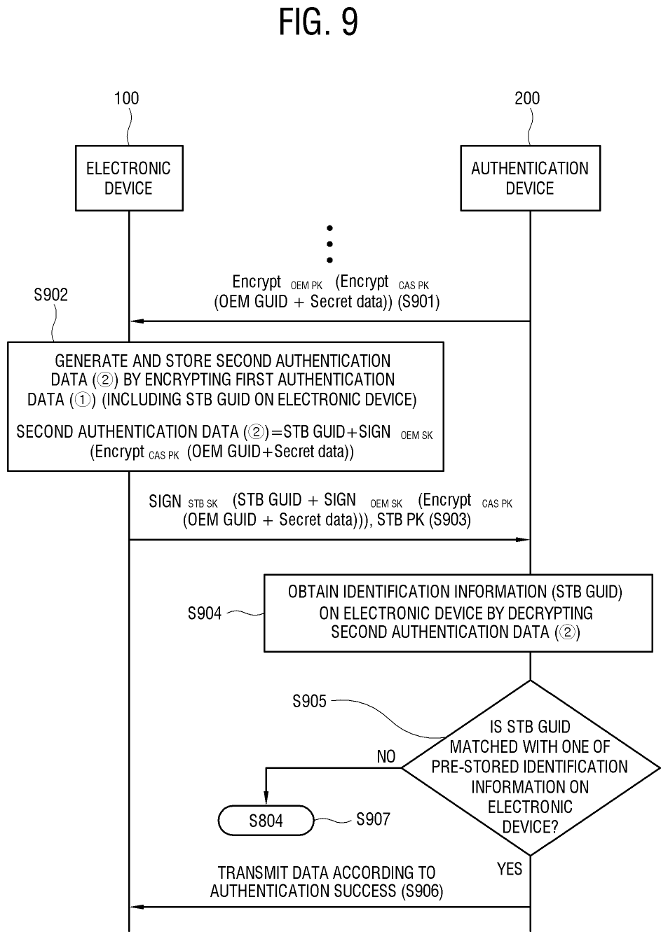

If the processor 202 of the authentication device 200 stores the list of the identification information on the electronic device 100 that is successfully authenticated, when the electronic device 100 corresponding to the list requests authentication later, the authentication may be performed faster than the initial authentication. This will be described with reference to FIG. 9. FIG. 9 illustrates the operation of the electronic device 100 and the authentication device 200 when the electronic device 100 that succeeds in the initial authentication requests authentication later.

Processes (S901 to S903) in which the processor 102 of the electronic device 100 receives the first authentication data from the authentication device 200, encrypts the received first authentication data to generate and store the second authentication data, and then transmits the second authentication data to the authentication device 200 to request the authentication are the same as the process of FIG. 8 described above. Alternatively, the processor 102 of the electronic device 100 may read the second authentication data previously generated and stored in the storage unit 103 of the electronic device 100 from the storage unit 103 without going through the above processes, and transmit the read second authentication data to the authentication device 200 to request the authentication.

The processor 202 of the authentication device 200 receiving the second authentication data from the electronic device 100 decrypts the second authentication data to obtain the STB GUID which is the identification information on the electronic device (S904). The processor 202 of the authentication device 200 compares the STB GUID obtained from the second authentication data with the list of the identification information on the electronic device 100 that is successfully authenticated and the list of identification information on the electronic device pre-stored in the storage unit 203 to determine whether or not the obtained STB GUID matches at least one identification information in the above list (S905). If it is determined that the obtained STB GUID matches at least one identification information, the processor 202 of the authentication device 200 transmits data according to the authentication success to the electronic device 100 (S906). If it is determined that the obtained STB GUID does not match at least one identification information, the processor 202 of the authentication device 200 performs the authentication on the electronic device 100 through the authentication process of FIG. 8, that is, the authentication process starting from S804 of FIG. 8 (S907).

As a result, when the electronic device that succeeds in the initial authentication again requests authentication later, the authentication can be performed more quickly.

1. An electronic device, comprising:
a communicator configured to communicate with an authentication device;
a storage configured to store data; and
a processor configured to:
encrypt first authentication data by causing the authentication device to encrypt identification information on the electronic device and unique data of the authentication device to generate second authentication data,
store the generated second authentication data in the storage, and
transmit the stored second authentication data to the authentication device to request authentication of the electronic device.

2. The electronic device of claim 1, wherein the processor is configured to encrypt the identification information on the electronic device and transmit the encrypted identification information to the authentication device.

3. The electronic device of claim 1, wherein the second authentication data further includes the identification information on the electronic device.

4. An electronic device, comprising:
a communicator configured to communicate with an authentication device;
a storage configured to store second authentication data generated by encrypting first authentication data by causing the authentication device to encrypt identification information on the electronic device and unique data of the authentication device; and
a processor configured to transmit the second authentication data stored in the storage to the authentication device to request authentication of the electronic device.

5. The electronic device of claim 4, wherein the second authentication data further includes the identification on the electronic device.

6. An authentication device, comprising:
a communicator configured to communicate with an electronic device; and
a processor configured to encrypt identification information on the electronic device and unique data of the authentication device to generate first authentication data and transmit the generated first authentication data to the electronic device.

7. The authentication device of claim 6, wherein the processor is configured to receive the identification information on the electronic device from the electronic device.

8. An authentication device, comprising:
a communicator configured to communicate with an electronic device; and
a processor configured to:
receive an authentication request of the electronic device and second authentication data from the electronic device,
decrypt the received second authentication data to obtain identification information on the electronic device and unique data of the authentication device, and
authenticate the electronic device based on the obtained identification information and unique data.

9. The authentication device of claim 8, further comprising:
a storage configured to store the identification information on the electronic device,
wherein the processor is configured to compare the obtained identification information with the identification information on the electronic device stored in the storage to authenticate the electronic device.

10. The authentication device of claim 8, further comprising:
a storage configured to store the identification information on the electronic device and unique data corresponding to the identification information,
wherein the processor is configured to compare the obtained identification information and unique data with the identification information on the electronic device and the unique data stored in the storage to authenticate the electronic device.

11. The authentication device of claim 8, further comprising:
a storage is configured to store data,
wherein the second authentication data further includes the identification information on the electronic device, and
the processor is configured to store the identification information on the electronic device included in the second authentication data in the storage when the electronic device is successfully authenticated.

12. The authentication device of claim 11, wherein the processor is configured to obtain the identification information on the electronic device from the second authentication data, and compare the obtained identification information on the electronic device with the identification information on the electronic device stored in the storage to authenticate the electronic device.

13. A control method of an electronic device communicating with an authentication device, comprising:
generating second authentication data by encrypting first authentication data by causing the authentication device to encrypt identification information on the electronic device and unique data of the authentication device;
storing the generated second authentication data; and
transmitting the stored second authentication data to the authentication device to request authentication of the electronic device.

14. The control method of claim 13, further comprising:
encrypting the identification information on the electronic device and transmitting the encrypted identification information to the authentication device.

15. The control method of claim 13, wherein the second authentication data further includes the identification information on the electronic device.
